(19) United States
(12) Patent Application Publication
(10) Pub. No.: US 2003/0035164 A1
(43) Pub. Date: Feb. 20, 2003

(54) Method of making an optical transmission system safe, a device for implementing the method, and an optical transmission system including the device

(75) Inventors: Laurent Labrunie, Paris (FR); Eric Brandon, Paris (FR); Patrice Le Roux, Villebon Sur Yvette (FR); Laurence Piriou, Savigny-Sur-Orge (FR); Roland Uhel, Clohars Carnoet (FR); Laurence Buet, Paris (FR); Vincent Havard, Choisy Le Roi (FR); Francois Boubal, Paris (FR)

Correspondence Address: SUGHRUE MION, PLLC, Suite 800, 2100 Pennsylvania Avenue, N.W., Washington, DC, 20037-3213, US

(73) Assignee: ALCATEL

(21) Appl. No.: 10/218,426

(22) Filed: Aug. 15, 2002

(30) Foreign Application Priority Data
Aug. 16, 2001 (FR) 01 10 850

(51) Int. Cl. H04B 10/08; H04B 10/12

(52) U.S. Cl. 359/110; 359/173

(57) ABSTRACT

A method of making an optical transmission system safe, the system including a transmission optical fiber and emitting an optical wanted signal, transmitting a transmitted optical signal containing the wanted optical signal and optical noise, sampling a portion of the transmitted optical signal constituting a monitoring optical signal, and analyzing the power of the monitoring optical signal to deduce, as a function of the power of the monitoring optical signal, whether the transmission optical fiber is broken. The method isolates in the monitoring optical signal a first signal containing only the noise and a second signal containing the noise and the wanted signal and compares the power of the first and second signals and to deduce that the transmission optical fiber is broken if the ratio of the power of the second signal to the power of the first signal is substantially equal to 1.

### CROSS-REFERENCE TO RELATED APPLICATIONS

This application is based on French Patent Application No. 01 10 850 filed Aug. 16, 2001, the disclosure of which is hereby incorporated by reference thereto in its entirety, and the priority of which is hereby claimed under 35 U.S.C. §119.

### BACKGROUND OF THE INVENTION

1. Field of the Invention

The present invention concerns a method of making an optical transmission system safe, a device for implementing the method, and an optical transmission system including the device, and more particularly a submarine optical transmission system made safe in this way.

2. Description of the Prior Art

In current submarine optical systems, optical fibers known as line fibers transmit wanted light signals (i.e. signals containing wanted information such as voice, data, control information, etc) between two optical regenerators, sometimes over very long distances. To compensate the attenuation of the signals over these long distances, these transmission systems use pump lasers with a very high power rating, of the order of one watt.

The pump lasers are used for amplification by optical fibers doped with erbium or for distributed Raman amplification.

In the case of amplification by optical fibers doped with erbium, a line optical fiber portion is replaced at regular intervals along the optical link by a portion of optical fiber doped with erbium; these optical fiber portions doped with erbium are therefore generally under the sea. The erbium ions therein are excited by a pump signal emitted by a pump laser. The interaction of the photons of the optical signal to be transmitted with the excited erbium ions amplifies the light signal.

In the case of distributed Raman amplification, it is not necessary to use portions of optical fiber doped with erbium, and the wanted light signal is amplified by stimulated Raman backscattering by sending a contrapropagating pump signal, for example.

In both cases, the pump laser, instead of being situated near the areas in which the amplification is required, i.e. under the sea, is at some distance from those areas, generally within regenerators for regenerating the light signal. The distances between the areas in which the signal must be amplified and the regenerators can be as much as several tens of kilometers, which explains among other things why the power rating of these lasers must be very high.

There is then a very high concentration of energy within the optical fibers, because of the very small diameter of the core of the fibers (which is of the order of 9 μm). In the regenerators, which are on land, human intervention is often needed to make connections and branch connections, to carry out repairs, etc. It is therefore clear that if a fiber is broken near a regenerator, i.e. where the optical power is the highest, for example after works have been carried out near it, there is great danger to the eyes of the persons having to work on the regenerators. Because of the very high concentration of energy transported by the fiber near the pump laser, light waves impinging on the human eye can cause irreparable damage.

A prior art method of avoiding this kind of problem is based on the loss of signal (LOS) principle. It consists of using an optical coupler placed on the line fiber near or at a distance from the exit of the pump laser and coupling a sample of the transmitted wanted signal into an ancillary monitor optical fiber. The ancillary optical fiber transmits the sampled signal to an analyzer situated at an interface of the transmission system, for example at a send/receive device, the analyzer controlling the pump laser. If the analyzer finds that the power of the sampled signal is substantially zero, i.e. that there is no signal, it concludes that the line fiber is broken at a point between the exit of the pump laser and the coupler and immediately commands interruption of emission by the pump laser.

This method causes a number of problems.

First of all, it takes no account of noise problems. Thus even if the line fiber is broken, optical noise caused by amplified spontaneous emission (ASE) and circulating in the direction opposite to that of the wanted signal continues to be transmitted and can have a high power. Consequently, even if the line fiber is broken, the signal sampled at the coupler may nevertheless have a high power, so that it is impossible to detect that the line fiber is broken.

Also, this method imposes the use of a portion of the wanted signal, which reduces the power of the latter and therefore leads to a loss on the signal.

Finally, it necessitates the use of an ancillary optical fiber.

Another prior art method of detecting a line fiber break near the pump laser avoids the noise problem. It is based on the loss of frame (LOF) principle. It consists of detecting the absence of frames in the sampled signal instead of a loss of power; optical noise has no specific frame, unlike the wanted signal.

However, this method is much more complex to implement than the method based on the LOS principle and requires dedicated equipment that is not always available at the interfaces of the transmission system.

An object of the present invention is therefore to provide a method of making an optical transmission system safe by using the LOS principle whilst avoiding the disadvantages associated with noise.

### SUMMARY OF THE INVENTION

To this end, the present invention proposes a method of making an optical transmission system safe, the system including a transmission optical fiber and being adapted:

to emit an optical wanted signal,

to transmit a transmitted optical signal containing the wanted optical signal and optical noise,

to sample a portion of the transmitted optical signal constituting a monitoring optical signal, and

to analyze the power of the monitoring optical signal to deduce, as a function of the power of the monitoring optical signal, whether the transmission optical fiber is broken,

which method is adapted to isolate in the monitoring optical signal a first signal containing only the noise and a second signal containing the noise and the wanted signal and to compare the power of the first and second signals and to deduce that the transmission optical fiber is broken if the ratio of the power of the second signal to the power of the first signal is substantially equal to 1.

According to the invention, by establishing the ratio between the power of two signals, one of which contains only noise, the prior art problem is avoided by isolating the two main components of the signal from each other, so that if there is only noise in the wanted signal, it can be deduced that the transmission fiber is broken.

Preferably, for enhanced safety, it is deduced that the transmission optical fiber is broken if the ratio of the power of the second signal to the power of the first signal is less than or equal to 2 and preferably less than or equal to 4.

In a preferred embodiment of the invention, each wavelength component of the monitoring optical signal is filtered to isolate wavelength components carrying only optical noise from wavelength components carrying the wanted signal and optical noise and the power of a signal carried by a wavelength carrying the wanted signal and the optical noise is compared to the power of a signal carried by a wavelength carrying only noise.

The power of each signal carried by a wavelength carrying the wanted signal and the optical noise is advantageously compared to the power of a signal carried by a wavelength carrying only noise.

This makes the method according to the invention more reliable because the noise and the signal are measured on several channels simultaneously, so that detection of a break remains possible in the event of failure of any channel.

The filtering is advantageously performed by filtering means that include a DWDM demultiplexer.

The sampling is advantageously performed by sampling means that include an optical coupler.

In another embodiment of the invention the monitoring signal is transmitted to a photodetector, the electrical signal from the photodetector is analyzed at two different frequencies to isolate an electrical signal corresponding to the optical noise from an electrical signal corresponding to the wanted signal and the optical noise, and the power of the two electrical signals is compared.

This other embodiment of the invention applies the method of the invention in the electrical domain rather than in the optical domain.

The invention also provides a device for implementing the above method, the device being adapted:

to isolate, in the monitoring optical signal, a first signal containing only the noise and a second signal containing the noise and the wanted signal, and

to compare the power of the first and second signals to deduce that the transmission optical fiber is broken if the ratio of the power of the second signal to the power of the first signal is substantially equal to 1.

For implementing the method according to the invention, the device according to the invention can further include means for commanding interruption of emission of a pump signal if the ratio of the powers is substantially equal to 1.

Finally, the invention provides an optical transmission system made safe by incorporating in it a device according to the invention.

Other features and advantages of the present invention will become apparent in the course of the following description of one embodiment of the invention, which is given by way of illustrative and non-limiting example only.

### BRIEF DESCRIPTION OF THE DRAWINGS

FIG. 1 shows diagrammatically a submarine optical transmission system according to the invention.

FIG. 2 shows one embodiment of a device according to the invention incorporated into the FIG. 1 transmission system to implement the method according to the invention.

### DETAILED DESCRIPTION OF THE PREFERRED EMBODIMENT

Items common to both figures are identified by the same reference number in both figures.

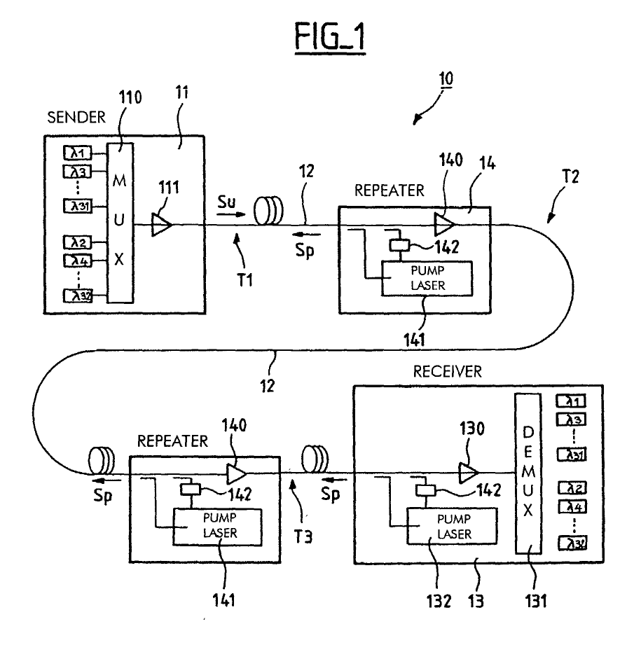

FIG. 1 shows a submarine optical transmission system 10 made safe by the invention. A submarine optical transmission system generally comprises a plurality of sections, of which three sections T1, T2 and T3 are shown in FIG. 1. A section is a portion of an optical transmission system situated between two devices for amplifying the optical signal, also known as repeaters. The received wavelength division multiplex (WDM) optical signal is amplified in a repeater before it is sent over the next section.

The system 10 includes:

an emitter 11 of WDM optical signals, i.e. of n signals carried by n separate channels with respective wavelengths λ₁ to λₙ; these n signals are combined in a multiplexer 110 to form the wanted signal Su; an amplifier 111 is used at the output of the multiplexer 110 in the conventional way

a line fiber 12 for transmitting the wanted signal Su,

a receiver 13 receiving the wanted signal Su at the other end of the transmission system 10; the optical signal Su is amplified in the receiver 13 by means of an amplifier 130 and then demultiplexed with the aid of a demultiplexer 131 to obtain n signals with wavelengths λ₁ to λₙ; the receiver 13 further includes a pump laser 132,

several repeater 14 between the emitter 11 and the receiver 13; each repeater 14 includes an amplifier 140 and a pump laser 141 injecting into the line fiber 12 a pump signal Sp for amplifying the wanted signal Su either using an erbium-doped fiber amplifier (in which case sections of erbium-doped fiber, not shown, are disposed at regular intervals in the line fiber 12) or by distributed Raman amplification; each repeater 14 also includes a device 142 according to the invention.

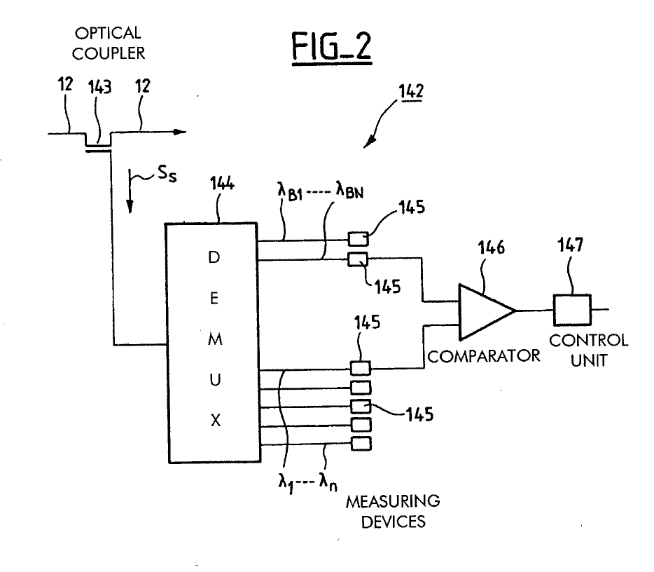

The device 142 according to the invention and the method according to the invention are described in detail next with reference to FIG. 2, which shows a device 142 in more detail.

The device 142 includes an optical coupler 143 (typically a 10:1 coupler) which samples 10% of the optical signal transmitted by the line fiber 12. This monitor optical signal S_{S}, which is used to detect a break in the line fiber 12, contains the WDM channels carried by respective wavelengths λ₁ to λₙ and noise generated by the components of the system, including amplified spontaneous emission associated with the amplification of the signal Su. The noise is carried by the wavelengths λ₁ to λₙ, being mixed with the signals carried by these wavelengths, and also by wavelengths separate from those of the wanted signal, here denoted λ_{B1} to λ_{BN}, where N is the number of wavelengths not carrying the wanted signal and between which the noise is divided.

In accordance with the invention, the signal Sₛ is sent to a WDM demultiplexer 144 for isolating the n+N signals contained in the signal Sₛ from each other.

The power of each of the demultiplexed signals is then measured by suitable measuring devices 145, after which at least one output of the measuring devices 145 giving the power of one of the signals with wavelengths λ₁ to λₙ is compared by a comparator 146 to an output of the measuring devices 145 giving the power of one of the noise signals with wavelengths λ_{B1} to λ_{BN}.

To be more precise, the ratio R of the power of one of the signals with wavelengths λ₁ to λₙ to the power of one of the noise signals with wavelengths λ_{B1} to λ_{BN} is calculated.

If this ratio R is less than or equal to 4, this means that the channel carrying the wanted signal is transporting only noise, and thus that the power of the wanted signal is zero; it is deduced from this that there is no wanted signal, and consequently that the line fiber 12 is broken. In this case, a control unit 147 sends a signal to the pump laser 141 to interrupt its emission.

If the ratio R is greater than 4, this means that the wanted signal is being transported between the output of the pump laser 141 and the coupler 143. In this case, the line optical fiber 12 is not broken and there is no danger to the human eye.

Clearly the method of the invention can already be put into effect if the ratio R is substantially equal to 1 (i.e. from 0.75 to 1.25), but it is preferable, for enhanced safety, to impose a higher maximum limit, for example equal to 2, or better still equal to 4.

To make monitoring more reliable and to guard against the possibility of failure of one of the WDM channels, several of the wavelengths λ₁ to λₙ can be compared to one of the wavelengths λ_{B1} to λ_{BN} at the same time.

For improved measurement accuracy, the power of the WDM signals can be compared to the power of each of the components carried by the wavelengths λ₁ to λ_{BN}.

Thus the method according to the invention makes optical transmission systems safe using the LOS method without being impeded by the problem of optical noise.

Furthermore, it imposes a laser emission interruption threshold to obtain the required safety and reliability within the transmission system.

Furthermore, unlike the LOS prior art method, the method of the invention does not necessitate an ancillary optical fiber.

The insertion losses of the sampling coupler can be compensated by increasing the gain of the amplifier 130 or 140 situated on the output side of the device according to the invention; in the prior art, sampling was effected ahead of distributed amplification with a fixed gain, which made it impossible to compensate the insertion losses.

Finally, it is much simpler than methods based on the prior art LOF principle.

Obviously, the invention is not limited to the embodiment that has just been described.

In particular, the signal and noise levels can be detected electrically instead of optically. In other words, all the components of the optical signal Sₛ are detected by means of a photodetector. The frequency of the electrical signal from the photodetector is filtered and for a modulated signal at 2.5 Gbit/s, for example, the power of the signal at 1 GHz, representing the wanted signal and the noise, is compared to that of the signal at 5 GHz, representing ASE. Once again, if the result is close to 1, for example, it is deduced that the line fiber 12 is broken, and emission by the pump laser is stopped.

Moreover, the invention can be put into effect in any optical transmission systems, not only in submarine optical transmission systems.

Also, it can be applied to detecting breaking of the optical fiber not only in the repeaters, but more generally in any device including a high-power optical emission source, whether that source serves as a pump laser or as a direct emission laser.

Finally, any means can be replaced by equivalent means without departing from the scope of the invention.

There is claimed:

1. A method of making an optical transmission system safe, said system including a transmission optical fiber and being adapted:
to emit an optical wanted signal,
to transmit a transmitted optical signal containing said wanted optical signal and optical noise,
to sample a portion of said transmitted optical signal constituting a monitoring optical signal, and
to analyze the power of said monitoring optical signal to deduce, as a function of said power of said monitoring optical signal, whether said transmission optical fiber is broken,
which method is adapted to isolate in said monitoring optical signal a first signal containing only said noise and a second signal containing said noise and said wanted signal and to compare the power of said first and second signals and to deduce that said transmission optical fiber is broken if the ratio of the power of said second signal to the power of said first signal is substantially equal to 1.

2. The method claimed in claim 1 wherein it is deduced that said transmission optical fiber is broken if said ratio is less than or equal to 2 and preferably less than or equal to 4.

3. The method claimed in claim 1 wherein each wavelength component of said monitoring optical signal is filtered to isolate wavelength components carrying only optical noise from wavelength components carrying said wanted signal and optical noise and the power of a signal carried by a wavelength carrying said wanted signal and said optical noise is compared to the power of a signal carried by a wavelength carrying only noise.

4. The method claimed in claim 3 wherein the power of each signal carried by a wavelength carrying said wanted signal and said optical noise is compared to the power of a signal carried by a wavelength carrying only noise.

5. The method claimed in claim 3 wherein said filtering is performed by filtering means that include a DWDM demultiplexer.

6. The method claimed in claim 3 or claim 4 wherein said sampling is performed by sampling means that include an optical coupler.

7. The method claimed in claim 1 wherein said monitoring signal is transmitted to a photodetector, the electrical signal from said photodetector is analyzed at two different frequencies to isolate an electrical signal corresponding to said optical noise from an electrical signal corresponding to said wanted signal, and the power of said two electrical signals is compared.

8. A device for implementing the method claimed in claim 1, said device being adapted:
to isolate, in said monitoring optical signal, a first signal containing only said noise and a second signal containing said noise and said wanted signal, and
to compare the power of said first and second signals to deduce that said transmission optical fiber is broken if the ratio of the power of said second signal to the power of said first signal is substantially equal to 1.

9. The device claimed in claim 8, further including means for commanding interruption of emission of a pump signal if said ratio is substantially equal to 1.

10. An optical transmission system including a device as claimed in either claim 8 or claim 9.
